(19) United States
(12) Patent Application Publication
(10) Pub. No.: US 2025/0322343 A1
(43) Pub. Date: Oct. 16, 2025

(54) SYSTEMS, METHODS, AND MEDIA FOR ATTRIBUTING VALUE TO MEMBERS OF AN ORGANIZATION

(71) Applicant: Jacob D. Chase, Denver, CO (US)

(72) Inventor: Jacob D. Chase, Denver, CO (US)

(21) Appl. No.: 18/814,851

(22) Filed: Aug. 26, 2024

Related U.S. Application Data
(60) Provisional application No. 63/633,391, filed on Apr. 12, 2024.

(51) Int. Cl. G06Q 10/0639; G06Q 10/1053

(52) U.S. Cl. CPC G06Q 10/0639; G06Q 10/1053

(57) ABSTRACT

The disclosed systems, methods, and computer-readable media for attributing value to a plurality of members of a company can be configured to retrieve, from each user device associated with at least a respective member, first user input data indicating a respective set of initial scores; assign a respective preliminary first member valuation to at least one member of a group; update a respective preliminary first member valuation assigned to each member of the group by performing an iterative method; generate at least one feature vector based at least on the each first user input data and the respective preliminary first member valuation assigned to each member of the group; provide the at least one feature vector to a machine learning model that is configured to generate final member valuations for the first group for generation of a recommendation that at least one member of the first group be replaced.

### CROSS-REFERENCE TO RELATED APPLICATION

This application claims the benefit of, and priority to, U.S. Patent Application No. 63/633,391 filed on Apr. 12, 2024, which is hereby incorporated by reference herein.

### FIELD OF DISCLOSURE

The present disclosure generally relates to the field of attributing value to a plurality of members of an organization.

### BACKGROUND

The process of attributing value is often biased and performed by one member or selected members of an organization such as a corporation, a company, a team, a club, a group, etc.

There is a need for a process of attributing value that incorporates scores assigned from each member to every other member in the organization or in a subset thereof. Such a process can incorporate a machine learning model and be performed on a blockchain to ensure that assigned scores can be validated by any member of the organization.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

At least one embodiment of the present disclosure includes a method for attributing value to a plurality of members of a company, the method comprising: determining that each user device of a plurality of user devices is associated with a respective member of a first group of the plurality of members of the company; retrieving, from each user device associated with at least a respective member, first user input data indicating a respective set of initial scores to be initially assigned to other members of the first group; assigning scores of each set of initial scores to respective members of the group; setting a group valuation for at least the group; assigning a respective preliminary first member valuation to each of at least one member of the group based at least on the group valuation; updating a respective preliminary first member valuation assigned to each member of the group by performing an iterative method comprising: determining a respective set of preliminary second member valuations assigned from each member in the group to other members in the group based at least on a respective preliminary first member valuation and a respective set of initial scores; producing a set of sums of valuations, wherein each sum of the set of sums of valuations is based on all preliminary second member valuations assigned to a respective member of the group; and updating the respective preliminary first member valuation assigned to each member of the group based on a respective sum of the set of sums of valuations; retrieving financial data associated with the company; retrieving stock data associated with the company; parsing each first user input data to generate a first plurality of features; parsing the respective preliminary first member valuation assigned to each member of the group to generate a second plurality of features; generating at least one feature vector based at least on the first plurality of features, the second plurality of features, the financial data associated with the company, and the stock data associated with the company; providing the at least one feature vector to a machine learning model that is configured to generate final member valuations to be assigned to respective members of the first group of the company for generation of a recommendation that at least one member of the first group be replaced.

In some embodiments, the method can include any method(s), process(es), or subprocess(es) disclosed herein.

At least another embodiment of the present disclosure includes a system for attributing value to a plurality of members of a company, the system comprising: memory; and one or more processors operably coupled to the memory and configured at least to: determine that each user device of a plurality of user devices is associated with a respective member of a first group of the plurality of members of the company; retrieve, from each user device associated with at least a respective member, first user input data indicating a respective set of initial scores to be initially assigned to other members of the first group; assign scores of each set of initial scores to respective members of the group; set a group valuation for at least the group; assign a respective preliminary first member valuation to each of at least one member of the group based at least on the group valuation; update a respective preliminary first member valuation assigned to each member of the group by performing an iterative method comprising: determining a respective set of preliminary second member valuations assigned from each member in the group to other members in the group based at least on a respective preliminary first member valuation and a respective set of initial scores; producing a set of sums of valuations, wherein each sum of the set of sums of valuations is based on all preliminary second member valuations assigned to a respective member of the group; and updating the respective preliminary first member valuation assigned to each member of the group based on a respective sum of the set of sums of valuations; retrieve financial data associated with the company; retrieve stock data associated with the company; parse each first user input data to generate a first plurality of features; parse the respective preliminary first member valuation assigned to each member of the group to generate a second plurality of features; generate at least one feature vector based at least on the first plurality of features, the second plurality of features, the financial data associated with the company, and the stock data associated with the company; provide the at least one feature vector to a machine learning model that is configured to generate final member valuations to be assigned to respective members of the first group of the company for generation of a recommendation that at least one member of the first group be replaced.

In some embodiments, the one or more processors can be configured to perform any method(s), process(es), or subprocess(es) disclosed herein.

At least another embodiment of the present disclosure includes a non-transitory computer-readable medium comprising instructions, that when executed by one or more processors, cause the one or more processors to perform a method for attributing value to a plurality of members of a company, the method comprising: determining that each user device of a plurality of user devices is associated with a respective member of a first group of the plurality of members of the company; retrieving, from each user device associated with at least a respective member, first user input data indicating a respective set of initial scores to be initially assigned to other members of the first group; assigning scores of each set of initial scores to respective members of the group; setting a group valuation for at least the group; assigning a respective preliminary first member valuation to each of at least one member of the group based at least on the group valuation; updating a respective preliminary first member valuation assigned to each member of the group by performing an iterative method comprising: determining a respective set of preliminary second member valuations assigned from each member in the group to other members in the group based at least on a respective preliminary first member valuation and a respective set of initial scores; producing a set of sums of valuations, wherein each sum of the set of sums of valuations is based on all preliminary second member valuations assigned to a respective member of the group; and updating the respective preliminary first member valuation assigned to each member of the group based on a respective sum of the set of sums of valuations; retrieving financial data associated with the company; retrieving stock data associated with the company; parsing each first user input data to generate a first plurality of features; parsing the respective preliminary first member valuation assigned to each member of the group to generate a second plurality of features; generating at least one feature vector based at least on the first plurality of features, the second plurality of features, the financial data associated with the company, and the stock data associated with the company; providing the at least one feature vector to a machine learning model that is configured to generate final member valuations to be assigned to respective members of the first group of the company for generation of a recommendation that at least one member of the first group be replaced.

In some embodiments, the non-transitory computer-readable medium can comprise instructions, that when executed by one or more processors, cause the one or more processors to perform any method(s), process(es), or subprocess(es) disclosed herein.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of a system for attributing value to members of an organization, according to some embodiments disclosed herein;

FIGS. 2A-2E illustrate tables of values generated or recorded when attributing value to members of an organization, according to some embodiments disclosed herein;

FIGS. 2F-2H illustrate user input forms for attributing value to members of an organization, according to some embodiments disclosed herein;

FIG. 3 illustrates a diagram of a system for utilizing a machine learning model for attributing value to members of an organization, according to some embodiments disclosed herein;

FIG. 4A illustrates a block diagram of a computer-readable medium comprising computer-readable instructions for attributing value to members of an organization, according to some embodiments disclosed herein;

FIG. 4B illustrates a block diagram of a computer-readable medium comprising computer-readable instructions for performing an iterative method for updating member valuations, according to some embodiments disclosed herein; and

FIG. 5 illustrates a block diagram of a computer-readable medium comprising computer-readable instructions for utilizing a blockchain to execute smart contracts associated with member valuations, according to some embodiments disclosed herein.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Regarding applicability of 35 U.S.C. § 112, paragraph 6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The present embodiments include a system, method, and computer-readable medium for attributing value to a plurality of members of an organization. The organization can be any formal or informal organization of people (i.e., users). For example, the organization can be a corporation, a company, a team, a club, a group, selected people thereof, etc.

In one embodiment, the system overcomes the limitations of existing methods by allowing any member(s) of an organization to contribute to the assignation of value to other members of the organization. An algorithm can be iteratively performed to update scores assigned to each member of the organization or a subset thereof until the scores change by less than a predetermined threshold. After iteratively performing the algorithm any suitable number of times, any members of the organization can be rewarded based on the updated assigned scores.

In at least one disclosed embodiment, the system may incorporate a machine learning model that is configured to receive at least one feature vector generated based at least on any assigned score data, updated score data, financial data, stock data, or any combination thereof, and generate final updated scores/member valuations. The final updated scores can be used to generate a recommendation that at least one member of a group be replaced (e.g., promoted, demoted, or let go) by another person (e.g., member of the organization).

The machine learning model can be trained using any suitable data such as, for example, user-assigned score data, company financial data (e.g., historical revenue data, historical profit data, historical debt data, etc.), company stock data (e.g., historical stock price data), user input data (e.g., user observation data, user feedback data), user interactions, user behavior data, or any combination thereof. The machine learning model can be configured to classify users into personality types based at least on user performance history, user behavior, and user track record.

The machine learning model can be further configured to recommend any member(s) for any open job position(s) based on member performance data. The machine learning model can be further configured to quantify expected future performance of members. The machine learning model can be further configured to predict optimal group composition based on member characteristics. The machine learning model can be further configured to predict generative feedback for the solicitation of additional feedback data from any member(s) of the organization. The machine learning model can be further configured to guide any member in navigating their career and building their member valuation.

In at least one disclosed embodiment, the system can incorporate blockchain technology for secure use of the assigned score data and member data. A blockchain consensus mechanism may be implemented where multiple nodes or instances of the system validate any assigned scores and any members of the organization. A blockchain consensus mechanism provides an additional layer of verification and reduces dependency on local databases. In one embodiment, user devices associated with members of the organization may be connected to a server over a blockchain network to achieve a consensus prior to executing a transaction to release the assigned score data and member data.

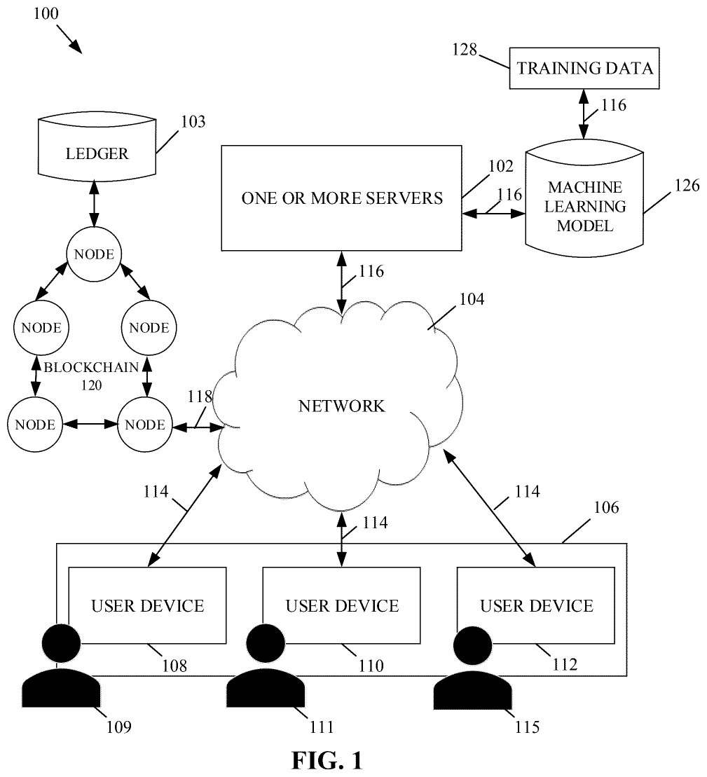

Referring to FIG. 1, a system 100 for attributing value to a plurality of members of an organization can be used with some embodiments disclosed herein. In some embodiments, system 100 can comprise one or more servers 102, a network 104 (e.g., communication network), one or more user devices 106 (i.e., computing devices 106), or any combination thereof. In some embodiments, the one or more user devices 106 can include a first user device 108, a second user device 110, a third user device 112, any other user device(s), or any combination thereof. In some embodiments, each of the one or more user devices 106 can be associated with a respective member of the organization. For example, each of the one or more user devices 106 can be operated by any members of any group of an organization such as, for example, a first member 109, a second member 111, and a third member 115.

The one or more servers 102 can be any suitable server(s) for storing data, programs, or a combination thereof, for attributing value to members of the organization. In some embodiments, the one or more servers 102 can store any data about user inputs from the one or more user devices 106, any suitable assigned score data, any suitable member valuation data about the members of the organization, and any suitable data about the organization (e.g., financial data, stock data, etc.).

In some embodiments, the one or more servers 102 can include one or more computing devices. In some embodiments, the one or more servers 102 can be configured to at least prompt any of the one or more user devices 106 to provide user input data indicating any scores to be assigned to any members of an organization, receive user input data from any of the one or more user devices 106, assign scores to any members of the organization based on any user input from any of the one or more user devices 106, set a group valuation for any members of the organization, update member valuations for any members of the organization by performing an iterative method, cause any member valuations to be presented on any user device(s), perform any method(s), process(es), or subprocess(es) disclosed herein, or any combination thereof.

In some embodiments, the one or more user devices 106 can include one or more computing devices. In some embodiments, the one or more user devices 106 can be configured to at least receive any suitable data from the one or more servers 102, be prompted by the one or more servers 102 to provide any user input indicating scores to be assigned to any members of the organization, present any suitable data received from the one or more servers 102, perform any method(s), process(es), or subprocess(es) disclosed herein, or any combination thereof.

A computing device can include a mobile device, such as a mobile phone, a tablet computer, a wearable computer, a laptop computer, a vehicle (e.g., a car, a boat, an airplane, or any other suitable vehicle), any other suitable mobile device, any suitable non-mobile device (e.g., a desktop computer, entertainment system, etc.), or any combination thereof. As another example, a computing device can include a media playback device, such as a television, a projector device, a game device or game console, any other suitable computing device, or any combination thereof.

The network 104 can include a wired network, a wireless network, or a combination thereof. In some embodiments, the network 104 can include the Internet, an intranet, a wide-area network (WAN), a local-area network (LAN), a digital subscriber line (DSL) network, a frame relay network, an asynchronous transfer mode (ATM) network, a virtual private network (VPN), any other suitable communication network, or any combination thereof. In some embodiments, one or more communications links 114 can connect the one or more user devices 106 to the network 104. In some embodiments, one or more communication links 116 can connect the network 104 to the one or more servers 102 and the machine learning model 126. In some embodiments, one or more communications links 118 can connect the network 104 to the blockchain 120. The one or more communication links 114, 116, 118 can be any communication links suitable for communicating information between the one or more user devices 106, the one or more servers 102, the blockchain 120, and the machine learning model 126 such as, for example, network links, dial-up links, wireless links, hard-wired links, any other suitable communications links, or any combination thereof.

While the one or more servers 102 are illustrated as one device, any suitable number of computing devices can be included in the one or more servers 102 in some embodiments.

While three user devices 108, 110, 112 are illustrated in FIG. 1 to avoid over-complicating the figure, any suitable number of computing devices can be included in the one or more user devices 106 in some embodiments.

In some embodiments, the one or more servers 102 and the one or more user devices 106 can be implemented using any suitable hardware. For example, any device of the one or more servers 102 and the one or more user devices 10 can be implemented using any suitable general-purpose computer or special-purpose computer.

The one or more servers 102 may also include a non-transitory computer readable medium that may have stored thereon computer-readable instructions executable by one or more processors. Examples of the computer-readable instructions are further discussed below. Examples of the non-transitory computer readable medium may include an electronic, magnetic, optical, or other physical storage device that contains or stores executable instructions. For example, the non-transitory computer readable medium may be a Random-Access memory (RAM), an Electrically Erasable Programmable Read-Only Memory (EEPROM), a hard disk, an optical disc, or other type of storage device.

The one or more processors may fetch, decode, and execute the computer-readable instructions to perform any method(s), process(es), or subprocess(es) disclosed herein.

In some embodiments, the one or more servers 102 and the one or more user devices 106 may use a decentralized storage such as a blockchain 120 that is a distributed storage system, which includes multiple nodes that communicate with each other over the network 104. The decentralized storage may include an append-only immutable data structure resembling a distributed ledger 103 capable of maintaining records between mutually untrusted parties. The untrusted parties are referred to herein as nodes. Each node maintains a copy of assigned value data and member data and no single node can modify the assigned value data and member valuation data without a consensus being reached among the distributed nodes. In some embodiments, the multiple nodes of the blockchain can include any of the one or more servers 102, any of the one or more user devices 106, or a combination thereof.

For example, any of the one or more servers 102, any of the one or more user devices 106, or a combination thereof may execute a consensus protocol to validate blockchain storage transactions, group the storage transactions into blocks, and build a hash chain over the blocks. A storage transaction may refer to the transfer of assigned score data and/or member data from a node to any other node in the blockchain 120. This process forms the ledger 103 by ordering the storage transactions, as is necessary, for consistency. In various embodiments, a permissioned and/or a permissionless blockchain can be used. In a public or permissionless blockchain, any member of an organization can participate without a specific identity. Public blockchains can involve assets and use consensus based on various protocols such as Proof of Work (PoW). A permissioned blockchain provides secure interactions among members of an organization which share a common goal such as storing assigned score data and member data, but which do not fully trust one another.

The blockchain 120 may be a permissioned (private) blockchain that operates arbitrary, programmable logic, tailored to a decentralized storage scheme and referred to as “smart contracts” or “chaincodes.” In some cases, specialized chaincodes may exist for management functions and parameters which are referred to as system chaincodes. The application can further utilize smart contracts that are trusted distributed applications which leverage tamper-proof properties of the blockchain database and an underlying agreement between nodes, which is referred to as an endorsement or endorsement policy. Blockchain transactions associated with this application can be “endorsed” before being committed to the blockchain 120 while transactions, which are not endorsed, are disregarded. An endorsement policy allows chaincodes to specify endorsers for a transaction in the form of a set of nodes that are necessary for endorsement. When a client sends the transaction to the nodes specified in the endorsement policy, the transaction is executed to validate the transaction. After a validation, the transactions enter an ordering phase in which a consensus protocol is used to produce an ordered sequence of endorsed transactions grouped into blocks.

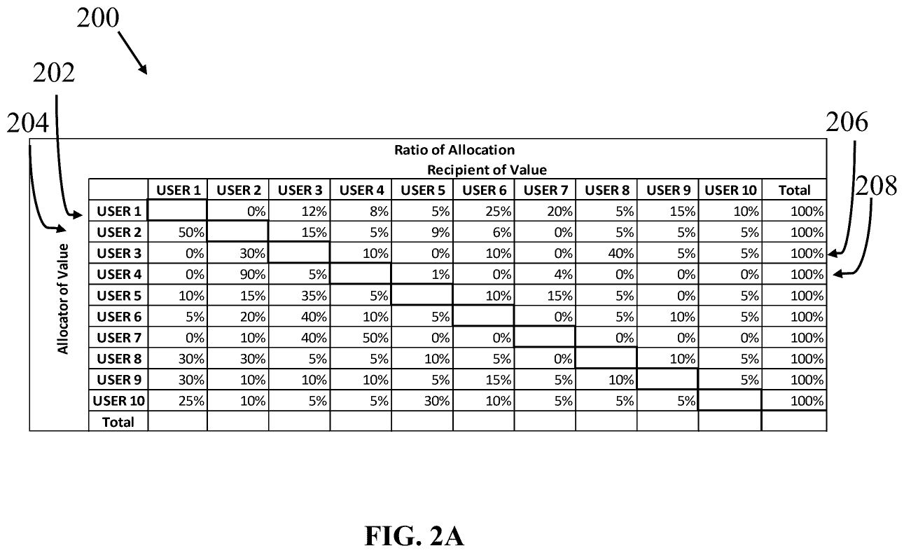

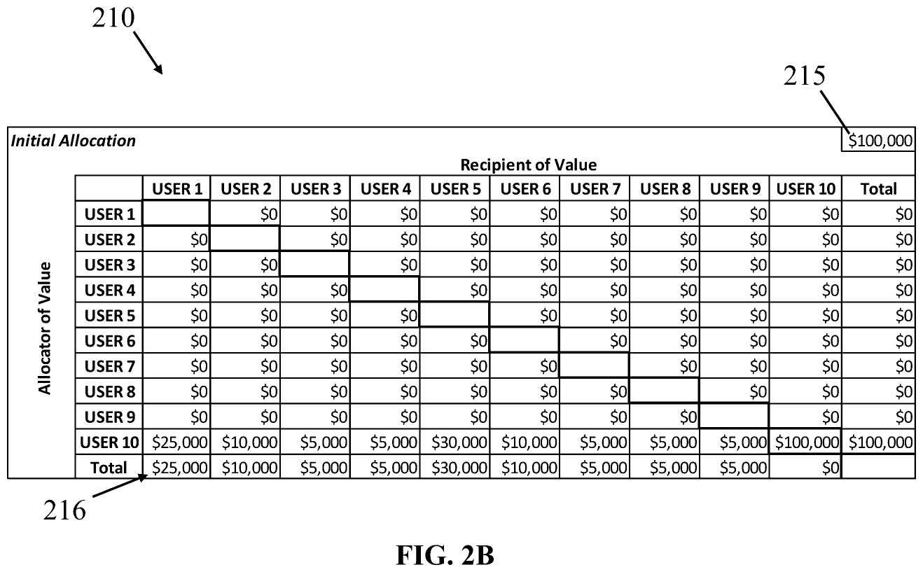

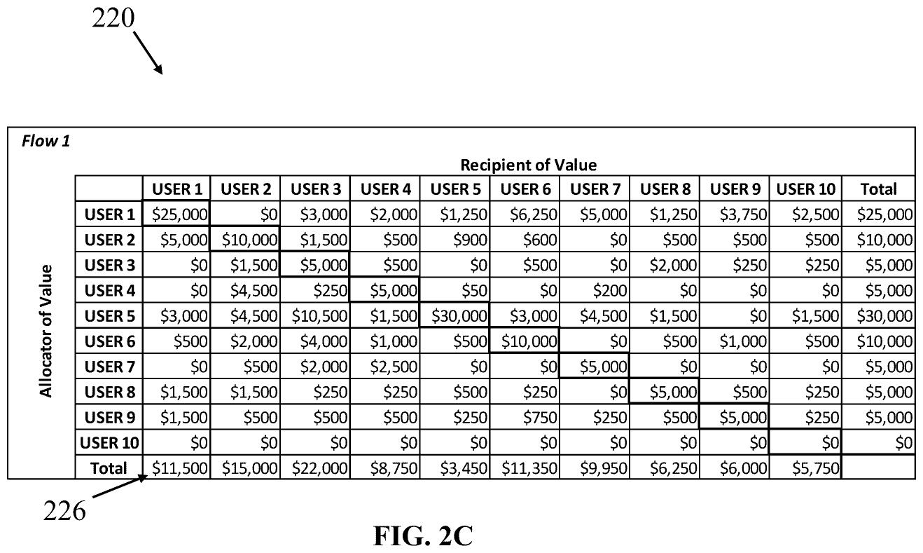

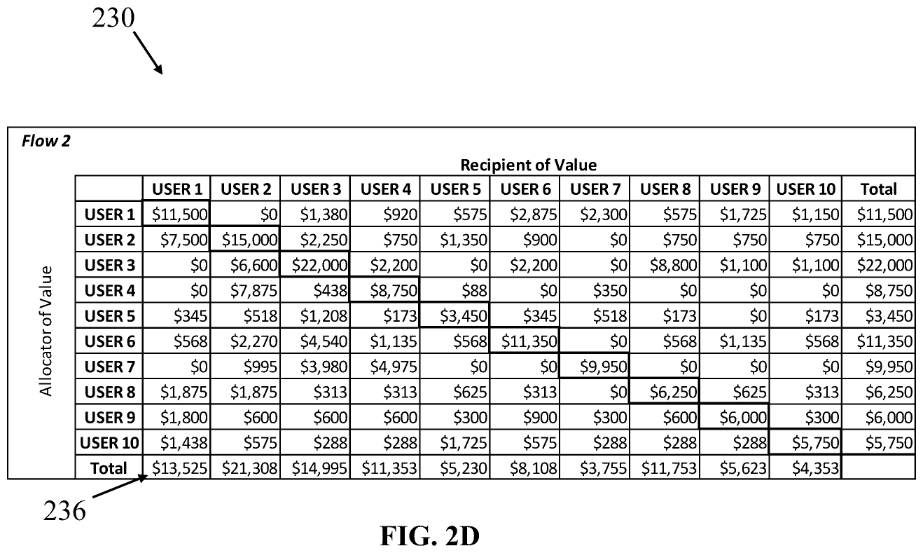

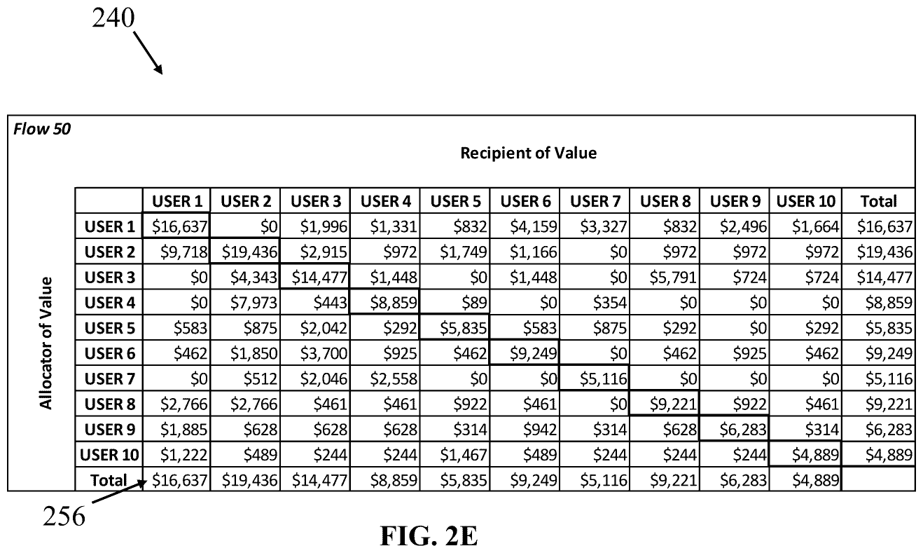

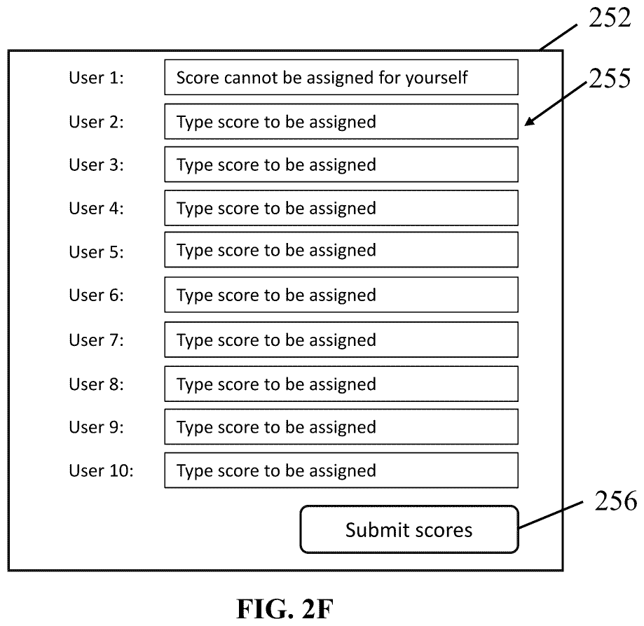

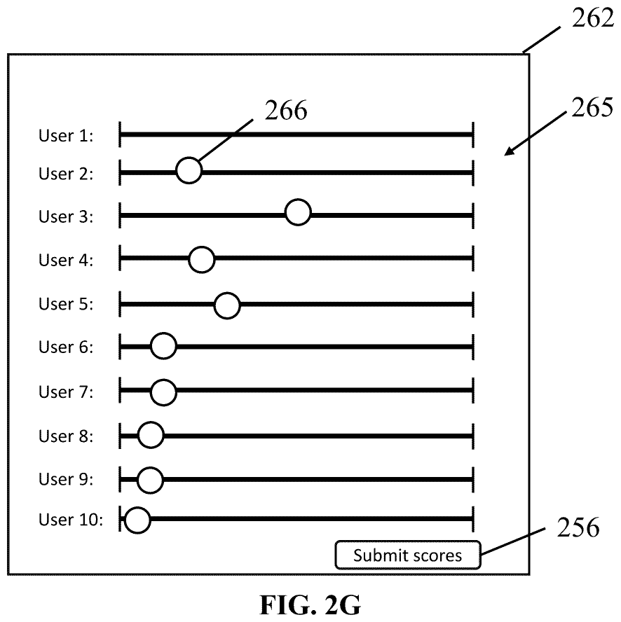

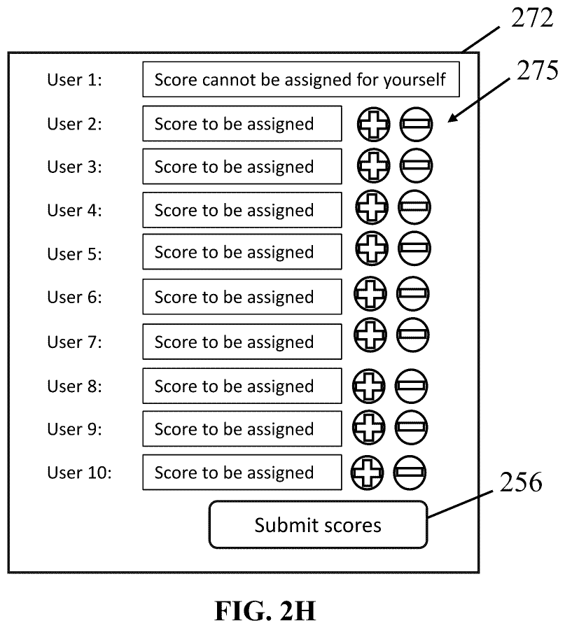

FIG. 2A shows a table 200 of values assigned by a first group of a plurality of members of an organization such as a company, as sent by their corresponding user devices. The first group can include users/members 1 to 10 of the organization. A user/member 1 can assign respective scores 202 to other users/members 2-10. A user/member 2 can assign respective scores 204 to other users/members 1 and 3-10. A user/member 3 can assign respective scores 206 to other users/members 1-2 and 4-10. A user/member 4 can assign respective scores 208 to other users/members 1-3 and 5-10. Each other user/member (e.g., user/members 5-10) can assign respective scores to other users/members of the first group.

FIG. 2B shows a table 210 of first member valuations determined by performing a first iteration of an iterative method. The first member valuations can be determined based at least on the assigned scores from any user/member (e.g., user/member 10) and a determined group valuation 215. For example, the scores in table 200, which can indicate percentages, can be multiplied by the group valuation 215 to determine the first member valuations. A set 216 of sums of valuations can be determined based on the member valuations, where each sum of valuations is a sum of member valuations in a respective column.

FIG. 2C shows a table 220 of second member valuations determined by performing a second iteration of the iterative method. The second member valuations can be determined based on the first member valuations and the assigned scores. Along the diagonal of the table 220 is the set 216 of sums of valuations. Member valuations in each row in the table 220 are determined based on the assigned scores from a particular user/member and a sum of the set 216 of sums of valuations included in a diagonal element (e.g., by multiplying a score with the sum of the set 216 of sums of valuations). A second set 226 of sums of valuations can be determined based on the second member valuations, where each sum of valuations is a sum of member valuations in a respective column.

FIG. 2D shows a table 230 of third member valuations determined by performing a third iteration of the iterative method. The third member valuations can be determined based on the second member valuations and the assigned scores. Along the diagonal of the table 230 is the set 226 of sums of valuations. Member valuations in each row in the table 220 are determined based on the assigned scores from a particular user/member and a sum of the set 226 of sums of valuations included in a diagonal element (e.g., by multiplying a score with the sum of the set 226 of sums of valuations). A third set 236 of sums of valuations can be determined based on the third member valuations, where each sum of valuations is a sum of member valuations in a respective column.

Further iterations of the iterative method can be performed to determine updated member valuations until each member valuation changes by less than a suitable predetermined amount.

FIG. 2E shows a table 240 of fourth member valuations determined by performing a fiftieth iteration of the iterative method. The fourth member valuations can be determined based on the member valuations determined by performing the forty-ninth iteration of the iterative method and the assigned scores. Along the diagonal of the table 240 is a set of sums of valuations determined by performing the forty-ninth iteration of the iterative method. Member valuations in each row in the table 240 are determined based on the assigned scores from a particular user/member and a sum of the set of sums of valuations included in a diagonal element (e.g., by multiplying a score with the sum of the set of sums of valuations). A set 256 of sums of valuations can be determined based on the member valuations determined by performing the forty-ninth iteration of the iterative method, where each sum of valuations is a sum of member valuations in a respective column.

In some embodiments, the set 256 of sums of valuation can be the final member valuations determined for the members of the first group.

Referring to FIG. 2F, a form 252 can be filled out by any user/member at a corresponding user device (e.g., 108, 110, 112 in FIG. 1) to assign initial scores to other users/members of the first group. Form fields 255 can be provided so that the user/member can manually type in the initial scores. The user/member can send the initial scores to one or more servers (e.g., 102 in FIG. 1) by selecting a submit button 256.

Referring to FIG. 2G, a second form 262 can be filled out by any user/member to assign initial scores to other users/members of the first group. Slider scales 265 can be provided so that the user/member can move slider icons 266 to indicate a set of initial scores. The user/member can send the initial scores to one or more servers (e.g., 102 in FIG. 1) by selecting the submit button 256.

Referring to FIG. 2H, a third form 272 can be filled out by any user/member to assign initial scores to other users/members of the first group. Up/down buttons 275 can be provided so that the user/member can select the up/down buttons 275 to indicate a set of initial scores. The user/member can send the initial scores to one or more servers (e.g., 102 in FIG. 1) by selecting the submit button 256.

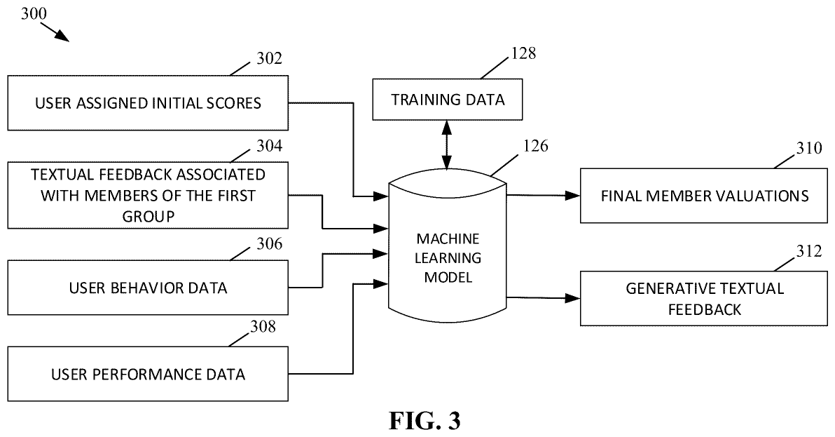

Referring to FIG. 3, a system 300 for utilizing a machine learning model 126 for attributing value to members of an organization is illustrated. In some embodiments, the assigned scores 302 of members of the first group, user textual feedback 304 associated with members of the first group, user behavior data 306 associated with members of the first group, and user performance data 308 associated with members of the first group can be parsed to generate a plurality of features that are used to generate at least one feature vector. The at least one feature vector can be provided to a machine learning model 126 that is configured to generate final member valuations 310 and generative textual feedback 312 for each member of the first group for the solicitation of additional user textual feedback from each member.

In some embodiments, the machine learning model 126 can be configured to generate final member valuations to be assigned to respective members of the first group of the company for generation of a recommendation that at least one member of the first group be replaced. In some embodiments, the machine learning model 126 can be configured to generate final member valuations to be assigned to respective members of the first group for the generation of a recommendation that the at least one member of the first group be considered for at least one open job position at the company. In some embodiments, the machine learning model 126 can be trained using training data 128 which can include any suitable data such as historical financial data associated with a company, historical stock data associated with the company, historical salary data associated with any members of the company, any user input data, any other suitable data, or any combination thereof.

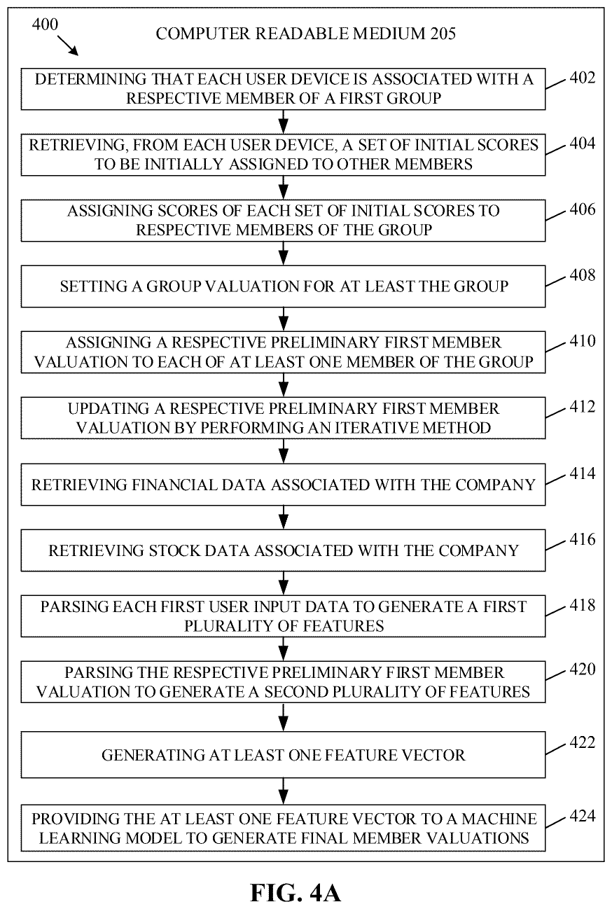

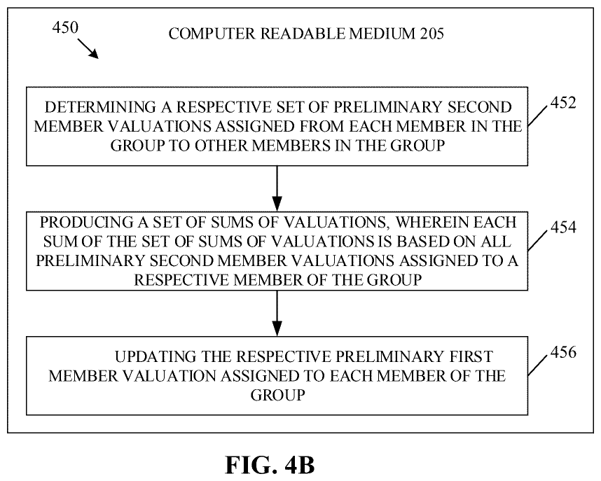

Referring to FIG. 4A, the one or more servers 102 in FIG. 1 can include a non-transitory computer-readable medium 205 comprising instructions 402-424 that, when executed by one or more processors, cause the processors to perform a process 400 for attributing value to a plurality of members of a company.

One or more processors may fetch, decode, and execute the computer-readable instructions 402 to determine that each user device of a plurality of user devices is associated with a respective member of a first group of the plurality of members of the company. One or more processors may fetch, decode, and execute the computer-readable instructions 404 to retrieve, from each user device associated with at least a respective member, first user input data indicating a respective set of initial scores to be initially assigned to other members of the first group. One or more processors may fetch, decode, and execute the computer-readable instructions 406 to assign scores of each set of initial scores to respective members of the group. One or more processors may fetch, decode, and execute the computer-readable instructions 408 to set a group valuation for at least the group. One or more processors may fetch, decode, and execute the computer-readable instructions 410 to assign a respective preliminary first member valuation to each of at least one member of the group based at least on the group valuation. One or more processors may fetch, decode, and execute the computer-readable instructions 412 to update a respective preliminary first member valuation assigned to each member of the group by performing an iterative method (e.g., 450 in FIG. 4B).

One or more processors may fetch, decode, and execute the computer-readable instructions 414 to retrieve financial data associated with the company. One or more processors may fetch, decode, and execute the computer-readable instructions 416 to retrieve stock data associated with the company. One or more processors may fetch, decode, and execute the computer-readable instructions 418 to parse each first user input data to generate a first plurality of features. One or more processors may fetch, decode, and execute the computer-readable instructions 420 to parse the respective preliminary first member valuation assigned to each member of the group to generate a second plurality of features. One or more processors may fetch, decode, and execute the computer-readable instructions 422 to generate at least one feature vector based at least on the first plurality of features, the second plurality of features, the financial data associated with the company, and the stock data associated with the company. One or more processors may fetch, decode, and execute the computer-readable instructions 424 to provide the at least one feature vector to a machine learning model (e.g., 126 in FIG. 3) that is configured to generate final member valuations to be assigned to respective members of the first group of the company for generation of a recommendation that at least one member of the first group be replaced.

Referring to FIG. 4B, the one or more servers 102 can include a non-transitory computer-readable medium 205 comprising instructions 452-456 that, when executed by one or more processors, cause the processors to perform an iterative method 450 for updating member valuations.

One or more processors may fetch, decode, and execute the computer-readable instructions 452 to determine a respective set of preliminary second member valuations assigned from each member in the group to other members in the group based at least on a respective preliminary first member valuation and a respective set of initial scores. One or more processors may fetch, decode, and execute the computer-readable instructions 454 to produce a set of sums of valuations, wherein each sum of the set of sums of valuations is based on all preliminary second member valuations assigned to a respective member of the group. One or more processors may fetch, decode, and execute the computer-readable instructions 456 to update the respective preliminary first member valuation assigned to each member of the group based on a respective sum of the set of sums of valuations.

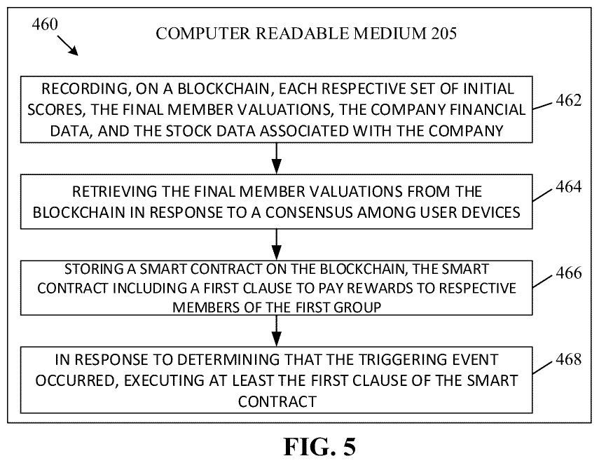

Referring to FIG. 5, the one or more servers 102 can include a non-transitory computer-readable medium 205 comprising instructions 462-468 that, when executed by one or more processors, cause the processors to perform a method 460 for utilizing a blockchain to execute smart contracts associated with member valuations.

One or more processors may fetch, decode, and execute the computer-readable instructions 462 to record, on a blockchain, each first user input data indicating a respective set of initial scores, the final member valuations assigned to respective members of the first group, the financial data associated with the company, and the stock data associated with the company. One or more processors may fetch, decode, and execute the computer-readable instructions 464 to retrieve the final member valuations assigned to respective members of the first group from the blockchain in response to a consensus among at least the plurality of user devices. One or more processors may fetch, decode, and execute the computer-readable instructions 466 to store a smart contract on the blockchain or in the database, the smart contract including a first clause to pay rewards to respective members of the first group based at least on the final member valuations assigned to respective members of the first group upon occurrence of a triggering event. One or more processors may fetch, decode, and execute the computer-readable instructions 468 to in response to determining that the triggering event occurred, execute at least the first clause of the smart contract to pay rewards to respective members of the first group based at least on the final member valuations assigned to respective members of the first group. In some embodiments, determining that the triggering event has occurred includes determining that a financial performance metric of the company (e.g., the company's revenue for the current year, the company's profit for the current year, etc.) meets a predetermined financial performance threshold (e.g., a revenue threshold, a profit threshold, etc.).

The computer computer-readable instructions may be embodied on a computer-readable medium, such as a storage medium. For example, the computer computer-readable instructions may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the one or more processors such that the one or more processors may read information from, and write information to, the storage medium. In the alternative, the storage medium may be integral to the one or more processors. The one or more processors and the storage medium may reside in an application specific integrated circuit (“ASIC”). In the alternative embodiment, the one or more processors and the storage medium may reside as discrete components.

The following variations is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and are still considered to be within the scope of the invention.

According to variation 1, a method for attributing value to a plurality of members of a company can include determining that each user device of a plurality of user devices is associated with a respective member of a first group of the plurality of members of the company; retrieving, from each user device associated with at least a respective member, first user input data indicating a respective set of initial scores to be initially assigned to other members of the first group; assigning scores of each set of initial scores to respective members of the group; setting a group valuation for at least the group; assigning a respective preliminary first member valuation to each of at least one member of the group based at least on the group valuation; updating a respective preliminary first member valuation assigned to each member of the group by performing an iterative method comprising: determining a respective set of preliminary second member valuations assigned from each member in the group to other members in the group based at least on a respective preliminary first member valuation and a respective set of initial scores; producing a set of sums of valuations, wherein each sum of the set of sums of valuations is based on all preliminary second member valuations assigned to a respective member of the group; and updating the respective preliminary first member valuation assigned to each member of the group based on a respective sum of the set of sums of valuations; retrieving financial data associated with the company; retrieving stock data associated with the company; parsing each first user input data to generate a first plurality of features; parsing the respective preliminary first member valuation assigned to each member of the group to generate a second plurality of features; generating at least one feature vector based at least on the first plurality of features, the second plurality of features, the financial data associated with the company, and the stock data associated with the company; providing the at least one feature vector to a machine learning model that is configured to generate final member valuations to be assigned to respective members of the first group of the company for generation of a recommendation that at least one member of the first group be replaced.

According to variation 2, a system for attributing value to a plurality of members of a company can include memory; and one or more processors operably coupled to the memory and configured at least to perform a method for attributing value to the plurality of members of the company, the method comprising determining that each user device of a plurality of user devices is associated with a respective member of a first group of the plurality of members of the company; retrieving, from each user device associated with at least a respective member, first user input data indicating a respective set of initial scores to be initially assigned to other members of the first group; assigning scores of each set of initial scores to respective members of the group; setting a group valuation for at least the group; assigning a respective preliminary first member valuation to each of at least one member of the group based at least on the group valuation; updating a respective preliminary first member valuation assigned to each member of the group by performing an iterative method comprising: determining a respective set of preliminary second member valuations assigned from each member in the group to other members in the group based at least on a respective preliminary first member valuation and a respective set of initial scores; producing a set of sums of valuations, wherein each sum of the set of sums of valuations is based on all preliminary second member valuations assigned to a respective member of the group; and updating the respective preliminary first member valuation assigned to each member of the group based on a respective sum of the set of sums of valuations; retrieving financial data associated with the company; retrieving stock data associated with the company; parsing each first user input data to generate a first plurality of features; parsing the respective preliminary first member valuation assigned to each member of the group to generate a second plurality of features; generating at least one feature vector based at least on the first plurality of features, the second plurality of features, the financial data associated with the company, and the stock data associated with the company; providing the at least one feature vector to a machine learning model that is configured to generate final member valuations to be assigned to respective members of the first group of the company for generation of a recommendation that at least one member of the first group be replaced.

According to variation 3, a non-transitory computer-readable medium can comprise instructions, that when executed by one or more processors, cause the one or more processors to perform a method for attributing value to a plurality of members of a company, the method comprising determining that each user device of a plurality of user devices is associated with a respective member of a first group of the plurality of members of the company; retrieving, from each user device associated with at least a respective member, first user input data indicating a respective set of initial scores to be initially assigned to other members of the first group; assigning scores of each set of initial scores to respective members of the group; setting a group valuation for at least the group; assigning a respective preliminary first member valuation to each of at least one member of the group based at least on the group valuation; updating a respective preliminary first member valuation assigned to each member of the group by performing an iterative method comprising: determining a respective set of preliminary second member valuations assigned from each member in the group to other members in the group based at least on a respective preliminary first member valuation and a respective set of initial scores; producing a set of sums of valuations, wherein each sum of the set of sums of valuations is based on all preliminary second member valuations assigned to a respective member of the group; and updating the respective preliminary first member valuation assigned to each member of the group based on a respective sum of the set of sums of valuations; retrieving financial data associated with the company; retrieving stock data associated with the company; parsing each first user input data to generate a first plurality of features; parsing the respective preliminary first member valuation assigned to each member of the group to generate a second plurality of features; generating at least one feature vector based at least on the first plurality of features, the second plurality of features, the financial data associated with the company, and the stock data associated with the company; providing the at least one feature vector to a machine learning model that is configured to generate final member valuations to be assigned to respective members of the first group of the company for generation of a recommendation that at least one member of the first group be replaced.

According to variation 4, the method can further comprise: recording, on a blockchain, each first user input data indicating a respective set of initial scores, the final member valuations assigned to respective members of the first group, the financial data associated with the company, and the stock data associated with the company.

According to variation 5, the method can further comprise: recording, retrieving the final member valuations assigned to respective members of the first group from the blockchain in response to a consensus among at least the plurality of user devices.

According to variation 6, the method can further comprise: recording, storing a smart contract on the blockchain or in the database, the smart contract including a first clause to pay rewards to respective members of the first group based at least on the final member valuations assigned to respective members of the first group upon occurrence of a triggering event.

According to variation 7, the method can further comprise: recording, determining that the triggering event occurred; in response to determining that the triggering event occurred, executing at least the first clause of the smart contract to pay rewards to respective members of the first group based at least on the final member valuations assigned to respective members of the first group.

According to variation 8, determining that the triggering event occurred includes determining that a financial performance metric of the company meets a predetermined financial performance threshold.

According to variation 9, the machine learning model is configured to generate the final member valuations to be assigned to respective members of the first group for the generation of a recommendation that the at least one member of the first group be considered for at least one open job position at the company.

According to variation 10, the method can further comprise: retrieving, from each user device associated with at least a respective member, second user input data indicating user textual feedback associated with other members of the first group; wherein the at least one feature vector is generated further based on at least each second user input data.

According to variation 11, the method can further comprise: retrieving, from each user device associated with at least a respective member, user behavior data; wherein the at least one feature vector is generated further based on at least each user behavior data.

According to variation 12, the method can further comprise: retrieving, from each user device associated with at least a respective member, user performance data; wherein the at least one feature vector is generated further based on at least each user performance data.

According to variation 13, the method can further comprise: retrieving, from each user device associated with at least a respective member, second user input data indicating user textual feedback associated with other members of the first group; retrieving, from each user device associated with at least a respective member, user behavior data; retrieving, from each user device associated with at least a respective member, user performance data; parsing each second user input data indicating user textual feedback to generate a third plurality of features; parsing each user behavior data to generate a fourth plurality of features; parsing each user performance data to generate a fifth plurality of features; generating at least one second feature vector based at least on the third plurality of features, the fourth plurality of features, and the fifth plurality of features; providing the at least one second feature vector to a machine learning language model that is configured to generate generative textual feedback for each member of the first group for the solicitation of additional user textual feedback.

According to variation 14, a method for attributing value to a plurality of members of an organization can include determining that each user device of a plurality of user devices is associated with a respective member of a group of the plurality of members of the organization; receiving, from each user device associated with at least a respective member, user inputs indicating a respective set of initial values to be initially assigned to other members of the group; assigning values of each set of initial values to respective members of the group; setting a reward amount for at least the group; assigning a respective preliminary first reward portion to each of at least one member of the group based at least on the reward amount; updating a respective preliminary first reward portion assigned to each member of the group by performing an iterative method comprising: determining a respective set of preliminary second reward portions assigned from each member in the group to other members in the group based on a respective preliminary first reward portion and a respective set of initial values; producing a set of sums of reward portions, wherein each sum of the set of sums of reward portions is based on all preliminary second reward portions assigned to a respective member of the group; and updating the respective preliminary first reward portion assigned to each member of the group based on a respective sum of the set of sums of reward portions; and causing the respective preliminary first reward portion for a respective member of the group to be presented on a respective user device of the plurality of user devices.

According to variation 15, a system for attributing value to a plurality of members of an organization can include memory; and one or more processors operably coupled to the memory and configured at least to perform a method, the method comprising determining that each user device of a plurality of user devices is associated with a respective member of a group of the plurality of members of the organization; receiving, from each user device associated with at least a respective member, user inputs indicating a respective set of initial values to be initially assigned to other members of the group; assigning values of each set of initial values to respective members of the group; setting a reward amount for at least the group; assigning a respective preliminary first reward portion to each of at least one member of the group based at least on the reward amount; updating a respective preliminary first reward portion assigned to each member of the group by performing an iterative method comprising: determining a respective set of preliminary second reward portions assigned from each member in the group to other members in the group based on a respective preliminary first reward portion and a respective set of initial values; producing a set of sums of reward portions, wherein each sum of the set of sums of reward portions is based on all preliminary second reward portions assigned to a respective member of the group; and updating the respective preliminary first reward portion assigned to each member of the group based on a respective sum of the set of sums of reward portions; and causing the respective preliminary first reward portion for a respective member of the group to be presented on a respective user device of the plurality of user devices.

According to variation 16, a non-transitory computer-readable medium can comprise instructions, that when executed by one or more processors, cause the one or more processors to perform a method for attributing value to a plurality of members of an organization, the method comprising: determining that each user device of a plurality of user devices is associated with a respective member of a group of the plurality of members of the organization; receiving, from each user device associated with at least a respective member, user inputs indicating a respective set of initial values to be initially assigned to other members of the group; assigning values of each set of initial values to respective members of the group; setting a reward amount for at least the group; assigning a respective preliminary first reward portion to each of at least one member of the group based at least on the reward amount; updating a respective preliminary first reward portion assigned to each member of the group by performing an iterative method comprising: determining a respective set of preliminary second reward portions assigned from each member in the group to other members in the group based on a respective preliminary first reward portion and a respective set of initial values; producing a set of sums of reward portions, wherein each sum of the set of sums of reward portions is based on all preliminary second reward portions assigned to a respective member of the group; and updating the respective preliminary first reward portion assigned to each member of the group based on a respective sum of the set of sums of reward portions; and causing the respective preliminary first reward portion for a respective member of the group to be presented on a respective user device of the plurality of user devices.

According to variation 17, the method can further comprise: causing slider scales to be presented at a first user device of the plurality of user devices, the first user device associated with a first member of the group, wherein the slider scales indicate a set of initial values to be initially assigned to other members of the group.

According to variation 18, the method can further comprise: causing buttons to be presented at a first user device of the plurality of user devices, the first user device associated with a first member of the group, wherein the buttons are associated with a set of initial values to be initially assigned to other members of the group.

According to variation 19, the method can further comprise: receiving at least a first user input from a first user device of the plurality of user devices, the first user input indicating a revised initial value to be assigned to a first member of the group; modifying a set of initial values assigned to the first member of the group based at least on the revised initial value; and updating the respective preliminary first reward portion assigned to each member of the group by performing the iterative method.

According to variation 20, the method can further comprise: receiving a request to filter the plurality of members of the organization based on one or more tags associated with the group of the organization; and filtering the plurality of members of the organization based on the one or more tags associated with the group of the organization.

According to variation 21, the method can further comprise: sending, to a first user device of the plurality of user devices, respective preliminary first reward portions assigned to respective members of the group.

According to variation 22, updating the respective preliminary first reward portion assigned to each member of the group by performing the iterative method comprises: updating the respective preliminary first reward portion assigned to each member of the group by repeating the iterative method until the respective preliminary first reward portion assigned to each member of the group changes by less than a predetermined threshold.

According to variation 23, the method can further comprise: allocating a fund equal to a preliminary first reward portion for a respective member of the group to the respective member of the group; initiating a transfer of the fund to a financial account associated with the respective member of the group.

According to variation 24, the method can further comprise: in response to updating the respective preliminary first reward portion assigned to each member, associating the respective preliminary first reward portion assigned to each member with a time indicator indicating when the respective preliminary first reward portion was updated.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

What is claimed is:

1. A method for attributing value to a plurality of members of a company, comprising:
determining that each user device of a plurality of user devices is associated with a respective member of a first group of the plurality of members of the company;
retrieving, from each user device associated with at least a respective member, first user input data indicating a respective set of initial scores to be initially assigned to other members of the first group;
assigning scores of each set of initial scores to respective members of the group;
setting a group valuation for at least the group;
assigning a respective preliminary first member valuation to each of at least one member of the group based at least on the group valuation;
updating a respective preliminary first member valuation assigned to each member of the group by performing an iterative method comprising:
determining a respective set of preliminary second member valuations assigned from each member in the group to other members in the group based at least on a respective preliminary first member valuation and a respective set of initial scores;
producing a set of sums of valuations, wherein each sum of the set of sums of valuations is based on all preliminary second member valuations assigned to a respective member of the group; and
updating the respective preliminary first member valuation assigned to each member of the group based on a respective sum of the set of sums of valuations;
retrieving financial data associated with the company;
retrieving stock data associated with the company;
parsing each first user input data to generate a first plurality of features;
parsing the respective preliminary first member valuation assigned to each member of the group to generate a second plurality of features;
generating at least one feature vector based at least on the first plurality of features, the second plurality of features, the financial data associated with the company, and the stock data associated with the company;
providing the at least one feature vector to a machine learning model that is configured to generate final member valuations to be assigned to respective members of the first group of the company for generation of a recommendation that at least one member of the first group be replaced.

2. The method of claim 1, further comprising:
recording, on a blockchain, each first user input data indicating a respective set of initial scores, the final member valuations assigned to respective members of the first group, the financial data associated with the company, and the stock data associated with the company.

3. The method of claim 2, further comprising:
retrieving the final member valuations assigned to respective members of the first group from the blockchain in response to a consensus among at least the plurality of user devices.

4. The method of claim 2, further comprising:
storing a smart contract on the blockchain or in a database, the smart contract including a first clause to pay rewards to respective members of the first group based at least on the final member valuations assigned to respective members of the first group upon occurrence of a triggering event.

5. The method of claim 4, further comprising:
determining that the triggering event occurred;
in response to determining that the triggering event occurred, executing at least the first clause of the smart contract to pay rewards to respective members of the first group based at least on the final member valuations assigned to respective members of the first group.

6. The method of claim 5, wherein determining that the triggering event occurred includes determining that a financial performance metric of the company meets a predetermined financial performance threshold.

7. The method of claim 1, wherein the machine learning model is configured to generate the final member valuations to be assigned to respective members of the first group for the generation of a recommendation that the at least one member of the first group be considered for at least one open job position at the company.

8. The method of claim 1, further comprising:
retrieving, from each user device associated with at least a respective member, second user input data indicating user textual feedback associated with other members of the first group;
wherein the at least one feature vector is generated further based on at least each second user input data.

9. The method of claim 1, further comprising:
retrieving, from each user device associated with at least a respective member, user behavior data;
wherein the at least one feature vector is generated further based on at least each user behavior data.

10. The method of claim 1, further comprising:
retrieving, from each user device associated with at least a respective member, user performance data;
wherein the at least one feature vector is generated further based on at least each user performance data.

11. The method of claim 1, further comprising:
retrieving, from each user device associated with at least a respective member, second user input data indicating user textual feedback associated with other members of the first group;
retrieving, from each user device associated with at least a respective member, user behavior data;
retrieving, from each user device associated with at least a respective member, user performance data;
parsing each second user input data indicating user textual feedback to generate a third plurality of features;
parsing each user behavior data to generate a fourth plurality of features;
parsing each user performance data to generate a fifth plurality of features;
generating at least one second feature vector based at least on the third plurality of features, the fourth plurality of features, and the fifth plurality of features;
providing the at least one second feature vector to a machine learning language model that is configured to generate generative textual feedback for each member of the first group for the solicitation of additional user textual feedback.

12. A system for attributing value to a plurality of members of a company, comprising:
memory; and
one or more processors operably coupled to the memory and configured at least to:
determine that each user device of a plurality of user devices is associated with a respective member of a first group of the plurality of members of the company;
retrieve, from each user device associated with at least a respective member, first user input data indicating a respective set of initial scores to be initially assigned to other members of the first group;
assign scores of each set of initial scores to respective members of the group;
set a group valuation for at least the group;
assign a respective preliminary first member valuation to each of at least one member of the group based at least on the group valuation;
update a respective preliminary first member valuation assigned to each member of the group by performing an iterative method comprising:
determining a respective set of preliminary second member valuations assigned from each member in the group to other members in the group based at least on a respective preliminary first member valuation and a respective set of initial scores;
producing a set of sums of valuations, wherein each sum of the set of sums of valuations is based on all preliminary second member valuations assigned to a respective member of the group; and
updating the respective preliminary first member valuation assigned to each member of the group based on a respective sum of the set of sums of valuations;
retrieve financial data associated with the company;
retrieve stock data associated with the company;
parse each first user input data to generate a first plurality of features;
parse the respective preliminary first member valuation assigned to each member of the group to generate a second plurality of features;
generate at least one feature vector based at least on the first plurality of features, the second plurality of features, the financial data associated with the company, and the stock data associated with the company;
provide the at least one feature vector to a machine learning model that is configured to generate final member valuations to be assigned to respective members of the first group of the company for generation of a recommendation that at least one member of the first group be replaced.

13. The system of claim 12, wherein the one or more processors are further configured to:
record, on a blockchain, each first user input data indicating a respective set of initial scores, the final member valuations assigned to respective members of the first group, the financial data associated with the company, and the stock data associated with the company.

14. The system of claim 13, wherein the one or more processors are further configured to:
retrieve the final member valuations assigned to respective members of the first group from the blockchain in response to a consensus among at least the plurality of user devices.

15. The system of claim 13, wherein the one or more processors are further configured to:
store a smart contract on the blockchain or in a database, the smart contract including a first clause to pay rewards to respective members of the first group based at least on the final member valuations assigned to respective members of the first group upon occurrence of a triggering event.

16. The system of claim 15, wherein the one or more processors are further configured to:
determine that the triggering event occurred;
in response to determining that the triggering event occurred, execute at least the first clause of the smart contract to pay rewards to respective members of the first group based at least on the final member valuations assigned to respective members of the first group.

17. A non-transitory computer-readable medium comprising instructions, that when executed by one or more processors, cause the one or more processors to perform a method for attributing value to a plurality of members of a company, the method comprising:
determining that each user device of a plurality of user devices is associated with a respective member of a first group of the plurality of members of the company;
retrieving, from each user device associated with at least a respective member, first user input data indicating a respective set of initial scores to be initially assigned to other members of the first group;
assigning scores of each set of initial scores to respective members of the group;
setting a group valuation for at least the group;
assigning a respective preliminary first member valuation to each of at least one member of the group based at least on the group valuation;
updating a respective preliminary first member valuation assigned to each member of the group by performing an iterative method comprising:
determining a respective set of preliminary second member valuations assigned from each member in the group to other members in the group based at least on a respective preliminary first member valuation and a respective set of initial scores;
producing a set of sums of valuations, wherein each sum of the set of sums of valuations is based on all preliminary second member valuations assigned to a respective member of the group; and
updating the respective preliminary first member valuation assigned to each member of the group based on a respective sum of the set of sums of valuations;
retrieving financial data associated with the company;
retrieving stock data associated with the company;
parsing each first user input data to generate a first plurality of features;
parsing the respective preliminary first member valuation assigned to each member of the group to generate a second plurality of features;
generating at least one feature vector based at least on the first plurality of features, the second plurality of features, the financial data associated with the company, and the stock data associated with the company;
providing the at least one feature vector to a machine learning model that is configured to generate final member valuations to be assigned to respective members of the first group of the company for generation of a recommendation that at least one member of the first group be replaced.

18. The method of claim 17, further comprising:
recording, on a blockchain, each first user input data indicating a respective set of initial scores, the final member valuations assigned to respective members of the first group, the financial data associated with the company, and the stock data associated with the company.

19. The method of claim 18, further comprising:
retrieving the final member valuations assigned to respective members of the first group from the blockchain in response to a consensus among at least the plurality of user devices.

20. The method of claim 18, further comprising:
storing a smart contract on the blockchain or in a database, the smart contract including a first clause to pay rewards to respective members of the first group based at least on the final member valuations assigned to respective members of the first group upon occurrence of a triggering event.
